(19) United States
(12) Patent Application Publication
(10) Pub. No.: US 2025/0150665 A1
(43) Pub. Date: May 8, 2025

(54) REMOTE CONTROL DEVICE FOR PREVENTING/REDUCING MALFUNCTION, ELECTRONIC DEVICE, AND CONTROL METHODS THEREOF

(71) Applicant: Samsung Electronics Co., Ltd., Suwon-si (KR)

(72) Inventors: Jongkeun LEE, Suwon-si (KR); Kwanyoung KIM, Suwon-si (KR); Minsup KIM, Suwon-si (KR); Kihyun SONG, Suwon-si (KR); Sukhoon YOON, Suwon-si (KR); Wonjae LEE, Suwon-si (KR)

(21) Appl. No.: 19/013,579

(22) Filed: Jan. 8, 2025

Related U.S. Application Data
(63) Continuation of application No. PCT/KR2023/010122, filed on Jul. 14, 2023.

(30) Foreign Application Priority Data
Sep. 5, 2022 (KR) 10-2022-0112031

(51) Int. Cl. H04N 21/422; H04N 7/025

(52) U.S. Cl. CPC H04N 21/42221; H04N 7/025

(57) ABSTRACT

A remote control device is disclosed. The remote control device includes: a communication interface, comprising communication circuitry, and at least one processor, comprising processing circuitry, connected to the communication interface, individually and/or collectively, configured to control the remote control device, wherein at least one processor, individually and/or collectively, may be configured to: based on a communication channel being established with an electronic device through a first communication module of the communication interface, receive a code, representing the electronic device, from the electronic device through the first communication module, and based on a first command being received after the communication channel is released, add the code to a control signal corresponding to the first command and control a second communication module of the communication interface to transmit the control signal to the electronic device, wherein the first communication module and the second communication module may use different communication methods.

### CROSS-REFERENCE TO RELATED APPLICATIONS

This application is a continuation of International Application No. PCT/KR2023/010122 designating the United States, filed on Jul. 14, 2023, in the Korean Intellectual Property Receiving Office and claiming priority to Korean Patent Application No. 10-2022-0112031, filed on Sep. 5, 2022, in the Korean Intellectual Property Office, the disclosures of each of which are incorporated by reference herein in their entireties.

### BACKGROUND

### Field

The disclosure relates to a remote control device, an electronic device, and control methods thereof and for example, to a remote control device for preventing/reducing a malfunction, an electronic device, and control methods thereof.

### Description of Related Art

Due to the development of electronic technologies, various types of electronic devices have been developed. In particular, remote control of various electronic devices is recently possible through an infrared ray (IR) communication.

The IR communication is a type of wireless communication and is a technology communicatively connecting a transmitter and a receiver, for example, a user may operate a TV through an IR communication of a remote controller.

In the IR communication, communication is possible only using a predefined protocol and in a standard where the relevant protocol is defined. In particular, each manufacturer uses a unique protocol and thus in the case of the same group of products made by one manufacturer, the same IR method and value may be applied.

Meanwhile, the IR communication is an infrared ray communication and thus is directional but may operate within a specific space by reflection and scattering of light, wherein if a product using the same IR protocol is positioned in the same space, there may be a problem that an unintentional device is controlled according to an IR signal.

### SUMMARY

According to an example embodiment of the disclosure, a remote control device includes: a communication interface, comprising communication circuitry, and at least one processor, comprising processing circuitry, connected to the communication interface to control the remote control device, wherein at least one processor, individually and/or collectively, is configured to: based on a communication channel for communication with an electronic device being formed through a first communication module of the communication interface, receive a code indicating the electronic device from the electronic device through the first communication module, based on a first command being received after the communication channel is released, add the code to a control signal corresponding to the first command and control a second communication module of the communication interface to transmit the control signal to the electronic device, and wherein the first communication module and the second communication module use a different communication method.

The remote control device may further include: memory, wherein at least one processor, individually and/or collectively, may be configured to: map information about the communication channel and the code, store the mapped information in the memory, and based on the first command being received after the communication channel is released, add the code to the control signal based on the mapped information stored in the memory.

At least one processor, individually and/or collectively, may be configured to: based on the communication channel for communication with another electronic device being reformed through the first communication module, re-receive the code indicating the another electronic device from the another electronic device through the first communication module, remap information about the reformed communication channel and the re-received code, and update the mapped information to the remapped information.

At least one processor, individually and/or collectively, may be configured to: based on a second command being received after the reformed communication channel is released, may add the re-received code to the control signal corresponding to the second command based on the remapped information stored in the memory, and control the second communication module to transmit the control signal to which the re-received code is added to the another electronic device.

At least one processor, individually and/or collectively, may be configured to: based on a third command being received after the communication channel for communication with the electronic device is reformed, may control the first communication module to transmit the control signal corresponding to the third command to the electronic device.

The remote control device may further include memory storing the code, wherein at least one processor, individually and/or collectively, may be configured to, based on another code being received from the electronic device while the communication channel is formed, update the code to the another code.

At least one processor, individually and/or collectively, may be configured to: based on a fourth command being received after the communication channel is released, add the another code to the control signal corresponding to the fourth command and control the second communication module to transmit the control signal to the electronic device.

At least one processor, individually and/or collectively, may be configured to add the code to a custom area of the control signal.

The first communication module may comprise a bidirectional wireless communication module comprising communication circuitry, and the second communication module may comprise a one-way wireless communication module comprising communication circuitry.

The first communication module may include a Bluetooth module including Bluetooth circuitry, and the second communication module may include an infrared communication module including infrared communication circuitry.

According to an example embodiment of the disclosure, an electronic device includes: a communication interface comprising communication circuitry, and at least one processor, comprising processing circuitry, connected to the communication interface and configured to control the remote control device, wherein at least one processor, individually and/or collectively, is configured to: based on a communication channel for communication with a remote control device being formed through a first communication module of the communication interface, control the first communication module to transmit a code indicating the electronic device to the remote control device, receive a control signal from the remote control device through a second communication module of the communication interface after the communication channel is released, and based on the control signal including the code, perform an operation corresponding to the control signal, wherein the first communication module and the second communication module may use a different communication method.

At least one processor, individually and/or collectively, may be configured to: based on receiving a command of changing the code to another code while the communication channel is formed, may control the first communication module to transmit the another code to the remote control device.

At least one processor, individually and/or collectively, may be configured to: receive another control signal from the remote control device through the second communication module after the communication channel is released, wherein based on the another control signal including the another code, at least one processor, individually and/or collectively, is configured to perform an operation corresponding to the another control signal.

At least one processor, individually and/or collectively, may be configured to, based on the custom area of the control signal including the code, perform an operation corresponding to the control signal.

The first communication module may be a bidirectional wireless communication module comprising communication circuitry, and the second communication module may be a one-way wireless communication module comprising communication circuitry.

The first communication module may be a Bluetooth module comprising Bluetooth circuitry, and the second communication module may be an infrared communication module comprising infrared communication circuitry.

According to an example embodiment of the disclosure, a method of controlling a remote control device includes: based on a communication channel for communication with an electronic device being formed through a first communication module included in the remote control device, receiving a code indicating the electronic device from the electronic device through the first communication module, and based on a first command being received after the communication channel is released, adding the code to a control signal corresponding to the first command and controlling a second communication module included in the remote control device to transmit the control signal to the electronic device, wherein the first communication module and the second communication module use a different communication method.

The receiving may include: mapping information about the communication channel and the code and storing the mapped information, and wherein the controlling may include based on the first command being received after the communication channel is released, adding the code to the control signal based on the mapped information.

The method may further include: based on the communication channel for communication with another electronic device being reformed through the first communication module, re-receiving the code indicating the another electronic device from the another electronic device through the first communication module, remapping information about the reformed communication channel and the re-received code, and updating the mapped information to the remapped information.

The method may further include: based on a second command being received after the reformed communication channel is released, adding the re-received code to the control signal corresponding to the second command based on the remapped information, and controlling the second communication module to transmit the control signal to which the re-received code is added to the another electronic device.

The method may further include: based on a third command being received after the communication channel for communication with the electronic device is reformed, controlling the first communication module to transmit the control signal corresponding to the third command to the electronic device.

The method may further include based on another code being received from the electronic device while the communication channel is formed, update the code to the another code.

The controlling, based on a fourth command being received after the communication channel is released, may include: adding the another code to the control signal corresponding to the fourth command and controlling the second communication module to transmit the control signal to the electronic device.

The controlling may include adding the code to a custom area of the control signal.

The first communication module may be a bidirectional wireless communication module comprising communication circuitry, and the second communication module may be a one-way wireless communication module comprising communication circuitry.

The first communication module may be a Bluetooth module comprising Bluetooth circuitry, and the second communication module may be an infrared communication module comprising infrared communication circuitry.

According to an example embodiment of the disclosure, a method of controlling an electronic device may include: based on a communication channel for communication with a remote control device being formed through a first communication module of the electronic device, controlling the first communication module to transmit a code indicating the electronic device to the remote control device, receiving a control signal from the remote control device through a second communication module of the electronic device after the communication channel is released, and based on the control signal including the code, performing an operation corresponding to the control signal, wherein the first communication module and the second communication module may use a different communication method.

The method may further include based on a command of changing the code to another code being received while the communication channel is formed, controlling the first communication module to transmit the another code to the remote control device.

The method may further include: receiving another control signal from the remote control device through the second communication module after the communication channel is released and based on the another control signal including the another code, performing an operation corresponding to the another control signal.

The performing may include based on the custom area of the control signal including the code, performing an operation corresponding to the control signal.

The first communication module may be a bidirectional wireless communication module comprising communication circuitry, and the second communication module may be a one-way wireless communication module comprising communication circuitry.

The first communication module may be a Bluetooth module comprising Bluetooth circuitry, and the second communication module may be an infrared communication module comprising infrared communication circuitry.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating example interference between a plurality of products to aid in understanding of the disclosure;

FIG. 2 is a block diagram illustrating an example configuration of a display system according to various embodiments;

FIG. 3 is a block diagram illustrating an example configuration of a remote control device according to various embodiments;

FIG. 4 is a block diagram illustrating an example configuration of a remote control device according to various embodiments;

FIG. 5 is a block diagram illustrating an example configuration of an electronic device according to various embodiments;

FIG. 6 is a signal flow diagram illustrating an example transmission operation of an electronic device according to various embodiments;

FIG. 7 is a table illustrating an example structure of a control signal according to various embodiments;

FIG. 8 is a signal flow diagram illustrating an example update operation of a code indicating an electronic device according to various embodiments;

FIG. 9 is a flowchart illustrating an example method of controlling a remote control device according to various embodiments; and

FIG. 10 is a flowchart illustrating an example method of controlling an electronic device according to various embodiments.

### DETAILED DESCRIPTION

Embodiments the disclosure provide a remote control device for preventing/reducing a malfunction of identical or similar products with one control signal, an electronic device, and control methods thereof.

The disclosure is described in greater detail below with reference to the appended drawings hereinafter.

The terms used in the disclosure are selected as general terms which are currently widely used as much as possible in consideration of functions in the disclosure but may be varied depending on intention of those skilled in the art or a precedent, appearance of new technologies, or the like. Also, there may be arbitrarily selected terms in a certain case and in this case, its meaning will be described in the relevant description part of the disclosure. Therefore, the terms used in the disclosure should be defined based on the meaning of the term and the entire content throughout the disclosure rather than the simple name of the term.

In the disclosure, the expression such as “have”, “may have”, “include”, or “may include” denotes the existence of such characteristics (e.g. a numerical value, a function, an operation, and a component such as a part) and does not exclude the existence of additional characteristics.

The expression “at least one of A and/or B” should be understood as referring to any one of “A” or “B” or “A and B”.

The expression “1st”, “2nd”, “first”, “second”, or the like used in the disclosure may be used to describe various elements regardless of any order and/or degree of importance, wherein such expression is used only to distinguish one element from another element and is not intended to limit the relevant element.

A singular expression include a plural expression, unless defined in the context otherwise. In the application, the term such as “include” or “consist of” should be understood as designating that there are such characteristics, numbers, steps, operations, components, parts, or a combination thereof described in the disclosure but not as excluding in advance the existence of one or more other characteristics, numbers, steps, operations, components, parts, or a combination thereof or possibility of adding the same.

In the disclosure, the term “user” may be referred to as a person who uses an electronic device or a device which uses the electronic device (e.g. an artificial intelligence (AI) electronic device).

Hereinafter, various example embodiments of the disclosure are described in greater detail with reference to the appended drawings.

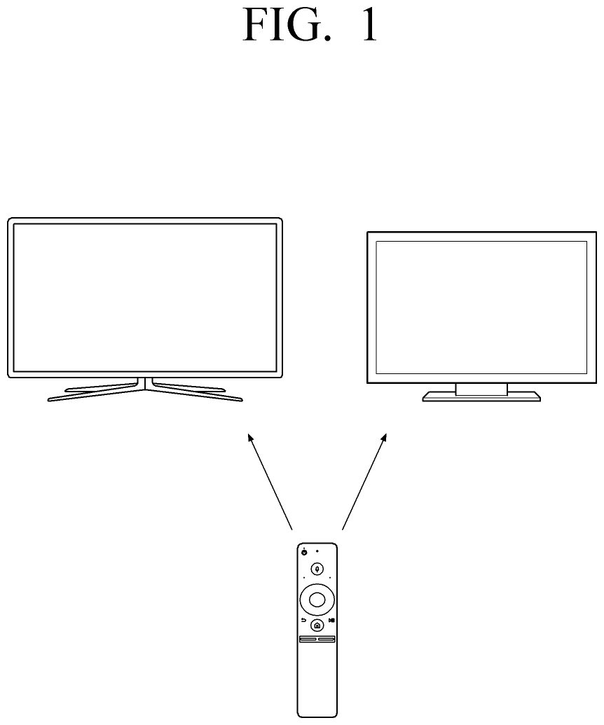

FIG. 1 is a diagram illustrating example interference between a plurality of products to aid in understanding of the disclosure.

The user may control a TV through a remote controller as shown in FIG. 1. The remote controller may be a TV dedicated remote controller.

Depending on a case, not only the TV but also a monitor may be controlled by the remote controller. For example, if all of the TV and monitor may be controlled through an infrared ray (IR) communication and two devices are positioned at one space, the TV and monitor may be controlled by an IR control signal of the remote controller. In particular, when the TV and monitor are products of the same manufacturer, if the user operates a power key of the remote controller, all of the TV and monitor may be turned on, wherein an operation that the monitor is turned on is not intended by the user, thereby resulting in inconvenience of the user. For example, there may be interference that two devices are controlled by one IR control signal.

A wireless communication method such as Bluetooth and Zigbee may be used but even in this case, a device is controlled by an IR communication in order to provide continuity of use during a state change such as pairing, connection, and disconnection and thus interference may occur. Therefore, a method for solving this problem is needed.

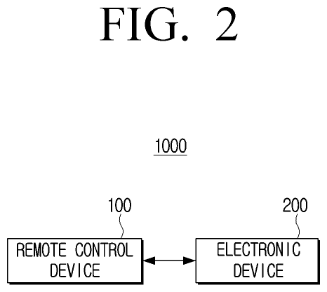

FIG. 2 is a block diagram illustrating an example configuration of a display system 1000 according to various embodiments. As shown in FIG. 2, the electronic system 1000 includes a remote control (e.g., including circuitry) device 100 and an electronic device (e.g., including circuitry) 200.

The remote control device 100 may include various circuitry and be a device performing communication with the electronic device 200 and controlling the electronic device 200. For example, the remote control device 100 may be a remote controller for controlling the electronic device 200. The disclosure is not limited thereto, wherein the remote control device 100 may be any device if the device may control the electronic device 200. For example, the remote control device 100 may be also a smart phone where an application for controlling the electronic device 200 is installed.

The remote control device 100 may perform communication targeted at the electronic device 200 but may perform communication targeted at unspecified multiple devices rather than the electronic device 200.

For example, if the remote control device 100 performs communication targeted at the electronic device 200, not only the electronic device 200 but also surrounding devices of the remote control device 100 may receive a signal transmitted by the remote control device 100 but only the electronic device 200 may perform an operation corresponding to the received signal.

The remote control device 100 may perform communication with the electronic device 200 in various communication standards. For example, the remote control device 100 may perform communication with the electronic device 200 in a Bluetooth communication standard, an infrared communication standard, or the like. In particular, if the remote control device 100 performs communication in the infrared communication standard, it may transmit a control signal including information corresponding to the electronic device 200 to the electronic device 200. In this case, another electronic device may receive the control signal of the infrared communication standard but may identify that the control signal is not a signal for controlling the another electronic device and may not perform any operation.

The electronic device 200 may include various circuitry and perform communication with the remote control device 100 and be controlled by the remote control device 100. For example, the electronic device 200 may be a device such as a TV, a computer, a monitor, a server, a speaker, a washing machine, a refrigerator, a tablet PC, a notebook PC, a dishwasher, a smart phone, la wearable device, or the like. The disclosure is not limited thereto, wherein the electronic device 200 may be any device if the device may be controlled by the remote control device 100.

The electronic device 200 may identify whether a control signal of the infrared communication standard received from the remote control device 100 includes information corresponding to the electronic device 200 or not. The electronic device 200, if the control signal of the infrared communication standard received from the remote control device 100 includes information corresponding to the electronic device 200, may perform an operation corresponding to the control signal and if the control signal of the infrared communication standard received from the remote control device 100 does not include information corresponding to the electronic device 200, may not perform any operation.

As above, operations of the remote control device 100 and the electronic device 200 included in the electronic system 1000 are briefly described. Hereinafter, an operation of preventing/reducing interference of the remote control device 100 and the electronic device 200 is described in greater detail with reference to the drawings.

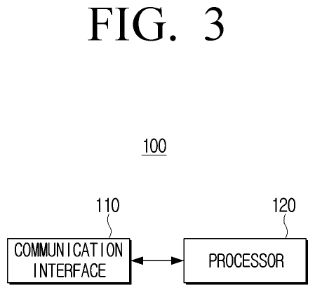

FIG. 3 is a block diagram illustrating an example configuration of a remote control device 100 according to various embodiments. According to FIG. 3, the remote control device 100 includes a communication interface (e.g., including communication circuitry) 110 and a processor (e.g., including processing circuitry) 120.

The communication interface 110 is a component performing communication with various types of external devices according to various types of communication methods. For example, the remote control device 100 may perform communication with the electronic device 200 through the communication interface 110.

The communication interface 110 may include various communication circuitry, including a WiFi module, a Bluetooth module, an infrared communication module, a wireless communication module, etc. Each communication module may be implemented in a form of at least one hardware chip.

The WiFi module and the Bluetooth module perform communication in a WiFi method and a Bluetooth method, respectively. In case of using the WiFi module or the Bluetooth module, the module may receive and transmit various connection information such as SSID and a session key in advance, connect communication using the connection information, and then receive and transmit various information. The infrared communication module may perform communication based on an infrared data association (IrDA) technology which transmits data wirelessly in a short distance using infrared light between visible light and a millimeter wave.

The wireless communication module may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G).

The communication interface 110 may include a wired communication interface such as a HDMI, DP, Thunderbolt, a USB, RGB, a D-SUB, a DVI, or the like.

The communication interface 110 may include at least one of a local area network (LAN) module, an Ethernet module, or a wired communication module performing communication using a pair cable, a coaxial cable, a fiber optic cable, or the like.

The processor 120 may include various processing circuitry and controls operations of the remote control device 100 overall. For example, the processor 120 may be connected to each component of the remote control device 100 to control operations of the remote control device 100 overall. For example, the processor 120 may be connected to a component such as the communication interface 110, memory (not shown), or the like to control operations of the remote control device 100.

At least one processor 120 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The at least one processor 120 may control one or any combination of other components of the remote control device 100 and perform an operation related to communication or data processing. The at least one processor 120 may perform one or more programs or instructions stored in the memory. For example, the at least one processor 120 may perform a method according to an embodiment of the disclosure by executing one or more instructions stored in the memory. The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by the second processor (e.g. an Artificial Intelligence (AI)-dedicated processor).

The at least one processor 120 may be implemented as a single core processor including one core and may be implemented as one or more multi core processors including a plurality of cores (e.g. homogeneous multicores or heterogeneous multicores). If the at least one processor 120 is implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In various embodiments of the disclosure, at least one processor 120 may refer, for example, to a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto. For convenience of the description, operations of the remote control device 100 are described based on the expression “processor 120”.

The processor 120 may form a communication channel for communication with the electronic device 200 through the first communication module of the communication interface 110. The first communication module may be a bidirectional wireless communication module. For example, the processor 120 may form a communication channel for communication with the electronic device 200 through the first communication module such as a Bluetooth module. For example, the processor 120 may perform pairing with the electronic device 200 and perform Bluetooth communication with the electronic device 200. Pairing may be a process of registering identification information between the remote control device 100 and the electronic device 200 in order to connect each other for operation.

The processor 120, if a communication channel for communication with the electronic device 200 is formed through the first communication module, may receive a code indicating the electronic device 200 from the electronic device 200 through the first communication module. The code for indicating the electronic device 200 may be any code for specifying the electronic device 200.

The processor 120, if the first command (e.g., first user command) is received after the communication channel is released, may add a code to a control signal corresponding to the first user command and control the second communication module of the communication interface 110 to transmit the control signal to the electronic device 200. The second communication module may be a one-way wireless communication module. For example, the processor 120, if the first user command is received after the Bluetooth communication channel is released, may add a code indicating the electronic device 200 to a control signal corresponding to the first user command and control the second communication module such as an infrared communication module to transmit the control signal to the electronic device 200. That is, the first communication module and the second communication module may use a different communication method.

In this case, since the code included in the control signal corresponds to the electronic device 200, the electronic device 200 may perform an operation corresponding to the control signal. When the code included in the control signal does not correspond to the another electronic device even though the another electronic device receives the control signal, the another electronic device does not perform any operation, wherein interference may be prevented/reduced.

The remote control device 100 further includes memory, wherein the processor 120 may map information about the communication channel and the code, store the mapped information in the memory, and if the first user command being received after the communication channel is released, add the code to the control signal on the mapped information stored in the memory. The information about the communication channel may include a type of communication channel, information about the opposite device of the communication channel, or the like.

The processor 120, if the communication channel for communication with the another electronic device is reformed through the first communication module, may re-receive the code indicating the another electronic device from the another electronic device through the first communication module, remap information about the reformed communication channel and the re-received code, and update the mapped information to the remapped information.

The processor 120, based on the second user command (e.g., second command) is received after the reformed communication channel is released, may add the re-received code to the control signal corresponding to the second user command based on the remapped information stored in memory, and control the second communication module to transmit the control signal to which the re-received code is added to the another electronic device.

That is, the processor 120 may store only information about the communication channel lastly formed through the first communication module. For example, if a Bluetooth communication channel for communication with a TV is formed, the remote control device 100 controls the TV, wherein if a Bluetooth communication channel for communication with a monitor is reformed, the remote control device 100 deletes all information about the TV and may store only information about the monitor where the communication channel is lastly formed. Then, the remote control device 100, if the Bluetooth communication channel is released, may add a code indicating a monitor to a control signal corresponding to a user command and control the infrared communication module to transmit the control signal to the monitor.

The processor 120 may store information about the communication channel lastly formed through the first communication module but it is merely an example. For example, the processor 120 may store information about all communication channels formed through the first communication module. For example, the processor 120, if a Bluetooth communication channel for communication with a TV is formed, may store information about the TV, wherein if a Bluetooth communication channel for communication with a monitor is reformed, it may additionally store information about the monitor separate from the information about the TV. Then, the processor 120, if the Bluetooth communication channel is released, may display a message of asking the user what code is added to the control signal corresponding to the user command, add the code corresponding to an additional user input to the control signal and control the infrared communication module to transmit the control signal. In this case, the remote control device 100 may further include a configuration such as a display in order to ask the user for the additional user input.

The remote control device 100 further may further include a sensor, wherein the processor 120, if a Bluetooth communication channel for communication with a TV is formed, may store information about the TV and may additionally store information about a position of the remote control device 100 obtained through the sensor and a direction to which the remote control device 100 is directed. The processor 120, if a Bluetooth communication channel for communication with a monitor is reformed, may store information about the monitor separate from the information about the TV and may additionally store information about a position of the remote control device 100 obtained through the sensor and a direction to which the remote control device 100 is directed. Since the TV and monitor are disposed in a different position and the user operates the remote control device 100 toward a device desired to be controlled among the TV and monitor, information about a position of the remote control device 100 and a direction to which the remote control device 100 is directed when operating the TV may be different from information when operating the monitor. Therefore, the processor 120, if the user command is received after the Bluetooth communication channel is released, may also obtain a position of the remote control device 100 and a direction to which the remote control device 100 is directed at a time point when the user command is received through the sensor, identify a device desired to be controlled by the user based on the obtained information, and add a code corresponding to the identified device to a control signal corresponding to the user command and control the infrared communication module to transmit the control signal.

The processor 120, if a third user command (e.g., third command) is received after the communication channel for communication with the electronic device 200 is reformed, may control the first communication module to transmit the control signal corresponding the third user command to the electronic device 200. For example, the processor 120, if a Bluetooth communication channel for communication with the electronic device 200 is released and then reformed, may transmit a control signal corresponding to the user command to the electronic device 200 through the Bluetooth communication channel rather than the infrared communication module.

The remote control device 100 may further include memory storing a code, wherein the processor 120, if another code is received from the electronic device 200 while the communication channel is formed, may update the code to the another code. The processor 120, if the fourth user command (e.g., fourth command) is received after the communication channel is released, may add the another code to a control signal corresponding to the fourth user command and control the second communication module to transmit the control signal to the electronic device 200. The another code may be information received from the electronic device 200 according to an operation that the user changes a code indicating the electronic device 200 to another code.

The processor 120 may add the code to a custom area of the control signal. The adding may include an operation of changing the existing default value. For example, the processor 120 may add a code to a control signal in a method of changing 0x07 which is a default value of the custom area of the control signal to 0x10 indicating the electronic device 200. Through this operation, the operations of the disclosure may be performed only with a software update without changing hardware of the conventional remote controller. Therefore, a cost may be reduced and stock management may be simple.

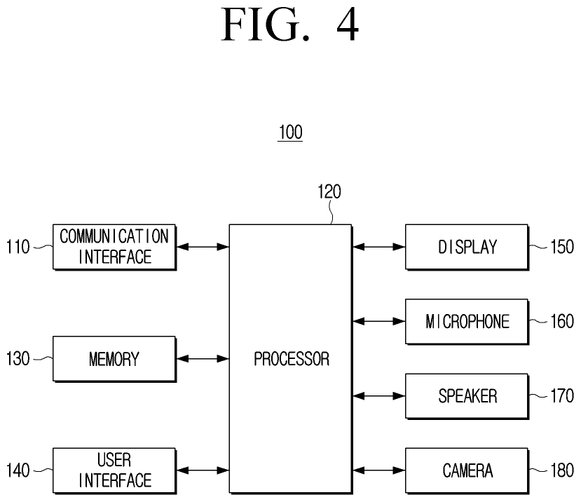

FIG. 4 is a block diagram illustrating an example configuration of a remote control device 100 according to various embodiments. The remote control device 100 may include the communication interface 110 and the processor 120. Also, according to FIG. 4, the remote control device 100 may further include memory 130, a user interface (e.g., including interface circuitry) 140, a display 150, a microphone 160, a speaker 170, and a camera 180. The detailed description of components overlapping with the components shown in FIG. 3 among the components shown in FIG. 4 may not be repeated here.

The memory 130 may refer to hardware storing information such as data in an electric or magnetic form in order that the processor 120 or the like may access thereto. For the above, the memory 130 may be implemented as at least one hardware of non-volatile memory, volatile memory, flash memory, a hard disk drive (HDD) or a solid state drive (SDD), RAM, or ROM.

The memory 130 may store at least one instruction required for an operation of the remote control device 100 or the processor 120. Here, the instructions may be written in a machine language, which is a computer-understandable language as a code unit instructing an operation of the remote control device 100 or the processor 120. The memory 130 may store a plurality of instructions performing specific work of the remote control device 100 or the processor 120 as an instruction set.

The memory 130 may store data which is information in a bit or bite unit indicating a character, a number, an image, or the like. For example, the memory 130 may store information about the electronic device 200.

The memory 130 may be accessed by the processor 120, wherein the processor 120 may perform reading/recording/correcting/deleting/renewing, or the like with respect to the instructions, the instruction set, or data.

The user interface 140 may include various interface circuitry and be implemented as a button, a touch pad, a mouse, a keyboard, or the like or may be implemented as a touch screen which may also perform together the display function and the operation input function. The button may be various types of buttons such as a mechanical button, a touch pad, or a wheel formed at any area such as a front part, a side part, a rear part, or the like of an appearance of a body of the remote control device 100. The processor 120 may receive a user command through the user interface 140.

The display 150 is a configuration for displaying an image and may be implemented as displays having various forms such as, for example, and without limitation, a liquid crystal display (LCD), an organic light emitting diode (OLED) display, a plasma display panel (PDP), or the like. The display 150 may include a driving circuit which may be implemented in a form such as an a-si TFT, a low temperature poly silicon (LTPS) TFT, or an organic TFT (OTFT), a backlight unit, or the like inside. Meanwhile, the display 150 may be implemented as a touch screen coupled to a touch sensor, a flexible display, a 3D display, or the like. The processor 120 may receive the user command through the display 150 and may control the display 150 to display a guide of requesting an additional command to the user.

The microphone 160 is a configuration for receiving sound and converting the sound to an audio signal. The microphone 160 may be electrically connected to the processor 120 and receive sound by control of the processor 120. For example, the microphone 160 may be formed as an integral type as being integrated into an upper side of the remote control device 100 or in a front direction, a side direction, or the like.

The microphone 160 may include various components such as a mike collecting sound in an analog form, an amp circuit amplifying the collected sound, an A/D conversion circuit sampling and converting the amplified sound to digital sound, and a filter circuit removing a noise component from the converted digital signal.

The microphone 160 may be implemented in a form of a sound sensor, wherein any type is proper if a configuration may collect sound.

The speaker 170 is a component outputting not only various audio data processed in the processor 120 but also various alarms, voice messages, or the like.

The remote control device 100 may further include the camera 180. The camera 180 is a configuration for capturing a static image or a moving image. The camera 180 may capture a static image of a specific time point but may successively capture the static image

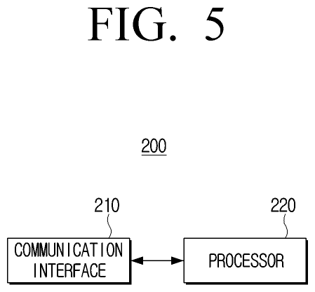

FIG. 5 is a block diagram illustrating an example configuration of an electronic device 200 according to various embodiments. According to FIG. 5, the electronic device 200 includes a communication interface (e.g., including communication circuitry) 210 and a processor (e.g., including processing circuitry) 220.

The communication interface 210 is a component performing communication with various types of external devices according to various types of communication methods. For example, electronic device 200 may perform communication with the remote control device 100 or a server through the communication interface 210.

The communication interface 210 may include various communication circuitry, including a WiFi module, a Bluetooth module, an infrared communication module, a wireless communication module, etc. Here, each communication module may be implemented in a form of at least one hardware chip.

The WiFi module and the Bluetooth module perform communication in a WiFi method and a Bluetooth method, respectively. In case of using the WiFi module or the Bluetooth module, the module may receive and transmit various connection information such as SSID and a session key in advance, connect communication using the connection information, and then receive and transmit various information. The infrared communication module may perform communication based on an infrared data association (IrDA) technology which transmits data wirelessly in a short distance using infrared light between visible light and a millimeter wave.

The wireless communication module may include at least one communication chip performing a communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G).

The communication interface 210 may include a wired communication interface such as a HDMI, DP, Thunderbolt, a USB, RGB, a D-SUB, a DVI, or the like.

The communication interface 210 may include at least one of a local area network (LAN) module, an Ethernet module, or a wired communication module performing communication using a pair cable, a coaxial cable, a fiber optic cable, or the like.

The processor 220 may include various processing circuitry and controls operations of the electronic device 200 overall. For example, the processor 220 may be connected to each component of the electronic device 200 to control operations of the electronic device 200 overall. For example, the processor 220 may be connected to a component such as the communication interface 210, memory (not shown), or the like to control operations of the electronic device 200.

At least one processor 220 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The at least one processor 220 may control one or any combination of other components of the electronic device 200 and perform an operation related to communication or data processing. The at least one processor 220 may perform one or more programs or instructions stored in the memory. For example, the at least one processor 220 may perform a method according to an embodiment of the disclosure by executing one or more instructions stored in the memory. The at least one processor 220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by the second processor (e.g. an Artificial Intelligence (AI)-dedicated processor).

The at least one processor 220 may be implemented as a single core processor including one core and may be implemented as one or more multi core processors including a plurality of cores (e.g. homogeneous multicores or heterogeneous multicores). If the at least one processor 220 is implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, at least one processor 220 may refer, for example, to a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto. Meanwhile, hereinafter, for convenience of the description, operations of the electronic device 200 are described based on the expression “processor 220”.

The processor 220 may form a communication channel for communication with the remote control device 100 through the first communication module of the communication interface 210. Here, the first communication module may be a bidirectional wireless communication module. For example, the processor 220 may form a communication channel for communication with the remote control device 100 through the first communication module such as a Bluetooth module. That is, the processor 220 may perform pairing with the remote control device 100 and perform Bluetooth communication with the remote control device 100.

The processor 220, if a communication channel for communication with the remote control device 100 is formed through the first communication module, may control the first communication module to transmit a code indicating the electronic device 200 to the remote control device 100.

The processor 220 may receive a control signal from the remote control device 100 through the second communication module of the communication interface 210 after the communication channel is released, wherein if the control signal includes a code, the processor may perform an operation corresponding to the control signal. For example, the processor 220 may receive a control signal from the remote control device 100 through the second communication module such as an infrared communication module after the Bluetooth communication channel is released, wherein if the control signal includes a code, the processor may perform an operation corresponding to the control signal. Here, the first communication module and the second communication module may use a different communication method.

As above, interference may be prevented/reduced through an operation identifying whether the control signal includes a code corresponding to the electronic device 200.

The processor 220, in response to receiving a user command of changing the code to another code from a user while the communication channel is formed, may control the first communication module to transmit the another code to the remote control device 100.

The processor 220 may receive another control signal from the remote control device 100 through the second communication module after the communication channel is released, wherein if the another control signal includes the another code, the processor may perform an operation corresponding to the another control signal.

The processor 220, if the custom area of the control signal includes the code, may perform an operation corresponding to the control signal.

The electronic device 200 may further include memory, a user interface, a display, a mike, a speaker, a camera, or the like, wherein a hardware configuration and a basic operation are the same as or similar to those of each configuration of FIG. 4 and thus the overlapped description is omitted.

The processor 220, if a communication channel for communication with the remote control device 100 is formed through the first communication module, may control the first communication module to transmit a code indicating the electronic device 200 to the remote control device 100 and after the communication channel is released, if the control signal is initially received from the remote control device 100 through the second communication module and the control signal includes the code, the processor 220 may display a message of confirming whether intention of the user is to control the electronic device 200. Further, the processor 220 may perform an operation corresponding to a control signal according to a confirmation operation of the user. Through this operation, it may be confirmed whether the code is exactly transmitted to the remote control device 100.

This operation may be useful if the remote control device 100 stores a plurality of codes. If the remote control device 100 stores a plurality of codes, there may be a need for a procedure of confirming whether the control signal includes a code corresponding to intention of the user, wherein the confirmation procedure may proceed through the operations of the electronic device 200 as above.

The remote control device 100 transmits the control signal including a code received from the electronic device 200 to the electronic device 200 and thus interference may be prevented/reduced. Also, the remote control device 100 transmits the control signal including the code to the custom area of the existing control signal and thus the operations of the disclosure may be performed only with a software update in the conventional hardware. Accordingly, a cost may be reduced and stock management may be simple.

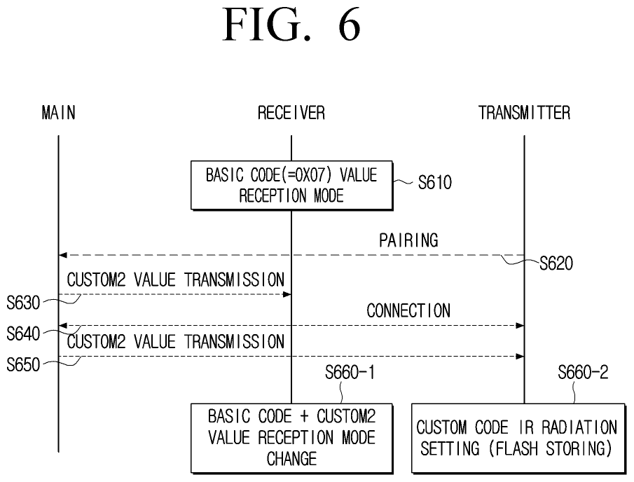

Hereinafter, operations of the remote control device 100 and the electronic device 200 are described in greater detail below with reference to FIGS. 6, 7 and 8 (which may be referred to as FIGS. 6 to 8). In FIGS. 6 to 8, individual examples are described for convenience of the description. The individual examples of FIGS. 6 to 8 may be embodied in any combined state.

FIG. 6 is a signal flow diagram illustrating an example transmission operation of a code indicating an electronic device 200 according to various embodiments. In FIG. 6, for convenience of the description, a processor 220 of the electronic device 200 is shown as “main”, a communication interface 210 of the electronic device 200 is shown as “receiver”, and a remote control device 100 is shown as “transmitter”. It is assumed that the receiver is implemented as a configuration having a processing ability such as, for example, a micom. The receiver may be implemented such that the processor 220 performs an operation of the micom without a separate micom.

In advance, the receiver may be in a mode receiving a basic custom code (0x07) value (S610). The basic custom code value is a value set upon manufacturing and may be a code value indicating the electronic device 200.

The receiver identifies whether the received control signal includes the basic custom code value, wherein only in the case of inclusion, the receiver may provide the control signal to the main and in the case of non-inclusion, the receiver may ignore the received control signal.

If the main is paired with the transmitter (S620), a custom2 value may be transmitted to the receiver (S630). The main, if a communication channel for communication with the transmitter is formed (S640), may transmit the custom2 value to the transmitter (S650).

The receiver is changed to a mode receiving the basic custom code (0x07) value and the custom2 value (S6610-1) and the transmitter may be set to store the custom2 value in flash memory and radiate a control signal including the custom2 value (S660-2). For example, the receiver identifies whether the received control signal includes the basic custom code (0x07) value or the custom2 value, wherein only in the case of inclusion, the receiver may provide the control signal to the main and in the case of non-inclusion, the receiver may ignore the received control signal. The transmitter, if the user command is received, may add the custom2 value to the control signal corresponding to the user command and radiate the control signal.

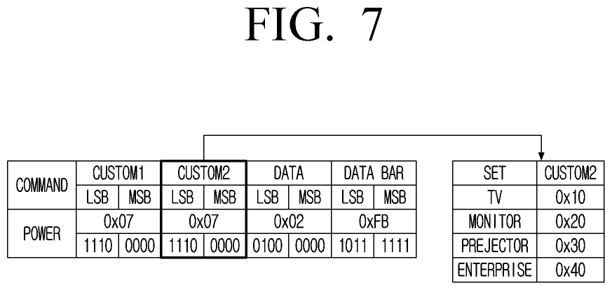

FIG. 7 is a table illustrating an example structure of a control signal according to various embodiments.

The processor 120 of the remote control device 100 may control the second communication module to radiate the control signal as shown in FIG. 7. The control signal of FIG. 7 may include information classified as “custom1”, “custom2”, “data”, and “data bar”, wherein the data and the data bar are codes corresponding to a user command.

The processor 120 may add a code indicating the electronic device 200 received from the electronic device 200 to the custom2 and transmit the control signal. For example, the processor 120 may change 0x07 of the custom2 to the code 0x30 indicating a projector and the custom2 may transmit the changed control signal. The projector may identify the control signal as a control signal for controlling the projector based on the code of the custom2 area of the control signal and then may perform an operation corresponding to the control signal. On the contrary, the TV may also receive a control signal but the code of the custom2 area of the control signal is 0x30 and thus the processor may identify that the relevant code is different from the code 0x10 indicating the TV and may not perform any operation.

FIG. 7 is merely an example of the structure of the control signal, wherein the structure thereof may be in any different standard and there may be various custom areas.

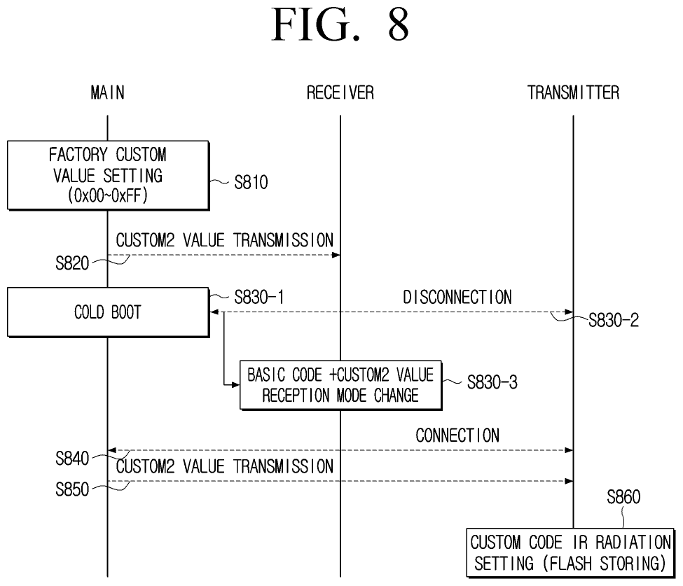

FIG. 8 is a signal flow diagram illustrating an example update operation of a code indicating an electronic device according to various embodiments. In FIG. 8, for convenience of the description, a processor 220 of the electronic device 200 is shown as “main”, a communication interface 210 of the electronic device 200 is shown as “receiver”, and a remote control device 100 is shown as “transmitter”. It is assumed that the receiver is implemented as a configuration having a processing ability such as, for example, a micom. The receiver may be implemented such that the processor 220 performs an operation of the micom without a separate micom.

The main may set a custom value according to the user command (S810) and may transmit the custom2 value to the receiver (S820).

The main nay be cold booted (S830-1), a communication connection with the transmitter is released (S830-2), and in a booting process, the main may control the receiver to operate in a mode of receiving the basic custom code value and the custom2 value (S830-3).

The main, if it is communicatively connected to the transmitter (S840), may transmit the custom2 value to the transmitter (S850).

The transmitter may be set to store the custom2 value in flash memory and radiate a control signal including the custom2 value (S860).

In FIG. 8, for convenience of the description, it is described that the custom2 is transmitted when the communication channel is reformed but the disclosure is not limited thereto. For example, the main may set a custom value and then directly transmit the set custom2 value to the receiver and the transmitter.

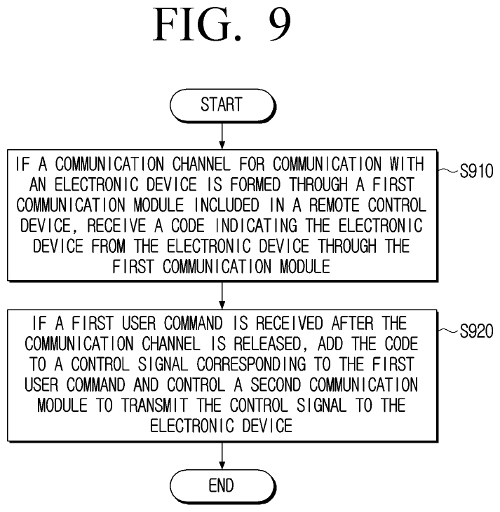

FIG. 9 is flowchart illustrating an example method of controlling a remote control device according to various embodiments.

In advance, the method includes if a communication channel for communication with an electronic device is formed through a first communication module included in the remote control device, receiving a code indicating the electronic device from the electronic device through the first communication module (S910). Further, the method includes if a first user command is received after the communication channel is released, adding the code to a control signal corresponding to the first user command and controlling a second communication module included in the remote control device to transmit the control signal to electronic device (S920). The first communication module and the second communication module may use a different communication method.

The receiving (S910) may include mapping information about a communication channel and a code and storing the mapped information and the controlling (S920) may include adding the code to the control signal based on the mapped information if the first user command is received after the communication is released.

The method may further include if the communication channel for communication with another electronic device is reformed through the first communication module, re-receiving the code indicating the another electronic device from the another electronic device through the first communication module, remapping information about the reformed communication channel and the re-received code, and updating the mapped information to the remapped information.

The method may further include if the second user command is received after the reformed communication channel is released, adding the re-received code to the control signal corresponding to the second user command based on the remapped information, and controlling the second communication module to transmit the control signal to which the re-received code is added to the another electronic device.

The method may further include if a third user command is received after the communication channel for communication with the electronic device is reformed, controlling the first communication module to transmit the control signal corresponding the third user command to the electronic device.

The method may further include if another code is received from the electronic device while the communication channel is formed, update the code to the another code.

The controlling (S920), if the fourth user command is received after the communication channel is released, may add another code to a control signal corresponding to the fourth user command and control the second communication module to transmit the control signal to the electronic device.

The controlling (S920) may add the code to a custom area of the control signal.

The first communication module may be a bidirectional wireless communication module, and the second communication module may be a one-way wireless communication module.

The first communication module may be a Bluetooth module, and the second communication module may be an infrared communication module.

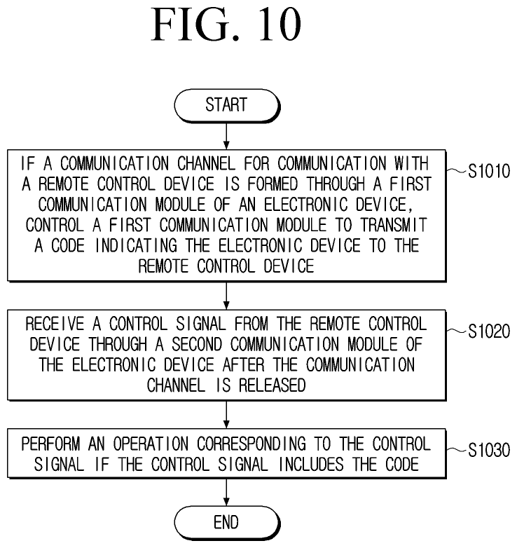

FIG. 10 is a flowchart illustrating an example method of controlling an electronic device according to various embodiments.

In advance, the method includes if the communication channel for communication with the remote control device is formed through the first communication module of the electronic device, controlling the first communication module to transmit a code indicating the electronic device to the remote control device (S1010). Further, the method includes receiving a control signal from the remote control device through the second communication module of the electronic device after the communication channel is released (S1020). Further, the method includes performing an operation corresponding to the control signal if the control signal includes the code (S1030). The first communication module and the second communication module may use a different communication method.

The method may further include if a user command of changing the code to another code is received from a user while the communication channel is formed, controlling the first communication module to transmit the another code to the remote control device.

The method may further include receiving another control signal from the remote control device through the second communication module after the communication channel is released and if the another control signal includes the another code, performing an operation corresponding to the another control signal.

The performing (S1030) may include if the custom area of the control signal includes the code, performing an operation corresponding to the control signal.

The first communication module may be a bidirectional wireless communication module, and the second communication module may be a one-way wireless communication module.

The first communication module may be a Bluetooth module, and the second communication module may be an infrared communication module.

According to various embodiments of the disclosure as above, the remote control device 100 transmits the control signal including a code received from the electronic device 200 to the electronic device 200 and thus interference may be prevented/reduced.

The remote control device 100 transmits the control signal including the code to the custom area of the existing control signal and thus the operations of the disclosure may be performed only with a software update in the conventional hardware. Accordingly, a cost may be reduced and stock management may be simple.

According to an embodiment of the disclosure, various examples described above may be implemented as software including instructions stored in machine-readable storage media, which can be read by a machine (e.g. a computer). The machine refers to a device which calls instructions stored in the storage media and is operable according to the called instructions, wherein the machine may include an electronic device (e.g. an electronic device A) according to the disclosed embodiments. If the instructions are executed by a processor, the processor may perform a function corresponding to the instructions directly or using other components under control of the processor. The instructions may include a code generated or executed by a compiler or an interpreter. A machine readable storage medium may be provided in a form of a non-transitory storage medium. Here, the ‘non-transitory’ storage medium does not include a signal and is tangible, wherein the term does not distinguish a case that data is stored in the storage medium semi-permanently from a case that data is stored in the storage medium temporarily.

According to an embodiment of the disclosure, a method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or on-line via an application store (e.g. Play Store™). In the case of on-line distribution, at least part of the computer program product may be stored at least temporarily or may be generated temporarily in a storage medium such as memory of a server of a manufacturer, a server of an application store, or a relay server.

According to an embodiment of the disclosure, various embodiments described as above may be implemented in a recording medium that may be read by a computer or a device similar thereto using software, hardware, or a combination thereof. In some cases, embodiments described in the disclosure may be implemented as a processor itself. According to software implementation, embodiments such as procedures and functions described in the disclosure may be implemented as separate software modules. Each of software modules may perform one or more functions and operations described in the disclosure.

Meanwhile, computer instructions for performing the processing operation of the machine according to the various embodiments above may be stored in a non-transitory computer readable medium. Computer instructions stored in this non-transitory computer readable medium that, when executed by a processor of a specific device, causes the specific device to perform a processing operation of the device according to the various embodiments. The non-transitory computer readable medium includes not only a medium storing data for a short time such as a resistor, a cache, memory, or the like but also a machine readable medium. An example of the non-transitory computer readable medium may be a CD, a DVD, a hard disk, a Blu-ray disk, a USB, a memory card, ROM, and the like.

Each of components (e.g. a module or a program) according to the various embodiments above may be configured as a single item or a plurality of items, wherein a partial subcomponent of the aforementioned relevant subcomponents may be omitted or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, or at least part of the operations may be executed in different orders or be omitted, or another operation may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A remote control device, comprising:
a communication interface comprising communication circuitry; and
at least one processor, comprising processing circuitry connected to the communication interface, individually and/or collectively, configured to control the remote control device,
wherein at least one processor, individually and/or collectively, is configured to:
based on a communication channel for communication with an electronic device being formed through a first communication module of the communication interface, receive a code indicating the electronic device from the electronic device through the first communication module; and
based on a first command being received after the communication channel is released, add the code to a control signal corresponding to the first command and control a second communication module of the communication interface to transmit the control signal to the electronic device, and
wherein the first communication module and the second communication module comprising communication circuitry and use a different communication method.

2. The remote control device of claim 1, further comprising:
memory,
wherein at least one processor, individually and/or collectively, is configured to:
map information about the communication channel and the code;
store the mapped information in the memory; and
based on the first command being received after the communication channel is released, add the code to the control signal based on the mapped information stored in the memory.

3. The remote control device of claim 2, wherein at least one processor, individually and/or collectively, is configured to:
based on the communication channel for communication with another electronic device being reformed through the first communication module, re-receive the code indicating the another electronic device from the another electronic device through the first communication module;
remap information about the reformed communication channel and the re-received code; and
update the mapped information to the remapped information.

4. The remote control device of claim 3, wherein at least one processor, individually and/or collectively, is configured to:
based on a second command being received after the reformed communication channel is released, add the re-received code to the control signal corresponding to the second command based on the remapped information stored in the memory, and
control the second communication module to transmit the control signal to which the re-received code is added to the another electronic device.

5. The remote control device of claim 1, wherein at least one processor, individually and/or collectively, is configured to:
based on a third command being received after the communication channel for communication with the electronic device is reformed, control the first communication module to transmit the control signal corresponding to the third user command to the electronic device.

6. The remote control device of claim 1, further comprising:
memory storing the code;
wherein at least one processor, individually and/or collectively, is configured to:
based on another code being received from the electronic device while the communication channel is formed, update the code to the another code.

7. The remote control device of claim 6, wherein at least one processor, individually and/or collectively, is configured to:
based on a fourth command being received after the communication channel is released, add the another code to the control signal corresponding to the fourth user command and control the second communication module to transmit the control signal to the electronic device.

8. The remote control device of claim 1, wherein at least one processor, individually and/or collectively, is configured to:
add the code to a custom area of the control signal.

9. The remote control device of claim 1, wherein the first communication module is a bidirectional wireless communication module comprising wireless communication circuitry, and
wherein the second communication module is a one-way wireless communication module comprising wireless communication circuitry.

10. The remote control device of claim 9, wherein the first communication module is a Bluetooth module, comprising Bluetooth circuitry, and
wherein the second communication module is an infrared communication module, comprising infrared communication circuitry.

11. A method of controlling a remote control device, comprising:
based on a communication channel for communication with an electronic device being formed through a first communication module included in the remote control device, receiving a code indicating the electronic device from the electronic device through the first communication module; and
based on a first command being received after the communication channel is released, adding the code to a control signal corresponding to the first user command and controlling a second communication module included in the remote control device to transmit the control signal to the electronic device,
wherein the first communication module and the second communication module, each comprise communication circuitry and use a different communication method.

12. The method of claim 11, wherein the receiving includes:
mapping information about the communication channel and the code and storing the mapped information, and
wherein the controlling includes:
based on the first command being received after the communication channel is released, adding the code to the control signal based on the mapped information.

13. The method of claim 12, further comprising:
based on the communication channel for communication with another electronic device being reformed through the first communication module, re-receiving the code indicating the another electronic device from the another electronic device through the first communication module;
remapping information about the reformed communication channel and the re-received code; and
updating the mapped information to the remapped information.

14. The method of claim 13, further comprising:
based on a second command being received after the reformed communication channel is released, adding the re-received code to the control signal corresponding to the second command based on the remapped information; and
controlling the second communication module to transmit the control signal to which the re-received code is added to the another electronic device.
